(19) United States
(12) Patent Application Publication
(10) Pub. No.: US 2024/0369400 A1
(43) Pub. Date: Nov. 7, 2024

(54) CURRENT TRANSMISSION DEVICE FOR A FORCE MEASURING APPARATUS, IN PARTICULAR A WEIGHING APPARATUS

(71) Applicant: WIPOTEC GmbH, Kaiserslautern (DE)

(72) Inventors: Jan Gottfriedsen, Waldfischbach-Burgalben (DE); Tobias Stellwagen, Kaiserslautern (DE); Alexander Schulzki, Stelzenberg (DE); Bernd Zinke, Mandelbachtal (DE)

(21) Appl. No.: 18/651,883

(22) Filed: May 1, 2024

(30) Foreign Application Priority Data
May 2, 2023 (DE) 10 2023 111 325.9

(51) Int. Cl. G01G 21/28

(52) U.S. Cl. CPC G01G 21/28

(57) ABSTRACT

The invention relates to current transmission device for a force measuring apparatus, in particular a weighing apparatus, wherein the force measuring apparatus (100) has a housing (102) and a base region as well as a moveable region. The current transmission device has a pressure-resistant housing (202), which can be fixedly connected mechanically to the base region of the force measuring apparatus (100), and a connecting element (216), which, at an outer end region that protrudes from the housing (202), can be fixedly connected mechanically to the moveable region of the force measuring apparatus (100) in an operating state. In an operating state, the connecting element (216) passes through the housing wall (208) in a contactless and ignition-safe manner. The connecting element (216) is embodied as a moveable cable pass-through and directs a first cable (220) into the interior of the housing. A housing-affixed cable feedthrough (206) directs a second cable into the interior of housing. An electrical connection that has a low force shunt is provided in the housing for the two cables. The current transmission device (200) is embodied in such a way that it can be mounted in a housing (102) or externally on a housing (102) of the force measuring apparatus (100). In addition, the invention relates to a force measuring apparatus (100) having such a current transmission device (200).

### REFERENCE TO PENDING PRIOR PATENT APPLICATION

This patent application claims benefit of German Patent Application No. 10 2023 111 325.9, filed May 2, 2023, which patent application is hereby incorporated herein by reference.

### FIELD OF THE INVENTION

The invention relates to a current transmission device for a force measuring apparatus, in particular a weighing apparatus.

### BACKGROUND OF THE INVENTION

In the case of the transmission of currents or electrical energy between two relatively moveable regions of a force measuring apparatus, taking suitable safety measures is required when using the force measuring apparatus in an explosion-endangered atmosphere. Such a force measuring apparatus for example can be a weighing apparatus, which has a conveyor belt with an electric drive, which, as an initial load, acts on a weighing cell arranged in a housing of the weighing apparatus. In this case, normally both electric supply lines are provided, which are directed for example from a power supply provided in the housing of the weighing apparatus or a power supply arranged in a separate housing on the housing of the weighing apparatus to the electric drive of the conveyor belt, as well as communication lines, which are directed from a control unit provided in the housing of the weighing apparatus to the electric drive of the conveyor belt.

Various methods are known in order to design this type of weighing apparatus to be explosion-proof. For example, the entire housing can be filled with a protective gas atmosphere. Because, in the case of a weighing apparatus from the housing, a load receptor or an element coupled therewith must always be guided out as contactlessly as possible, i.e., having low force shunt, it would be necessary, in the region of the passage opening, for the load receptor to be provided either with a completely tight seal between the load receptor with as low force shunt as possible, for example a bellows, or an adequately small gap between the load receptor and the passage opening, which can also be sealed by means of a labyrinth seal. In the case of a completely tight seal, the housing can be filled (statically) with a protective gas atmosphere. With a remaining gap between the load receptor and the passage opening, protective gas must be supplied continuously (dynamic protective gas atmosphere), in order to prevent the protective gas atmosphere from getting diluted to such an extent over the course of time that an explosion-endangered atmosphere develops. A slight overpressure hereby develops in the housing, which prevents an explosion-endangered atmosphere from forming in the housing. In this case, normal ambient air can also be used instead of a protective gas, as long as it is ensured that said ambient air does not have any explosion-endangered constituents.

Such a weighing apparatus can also be designed to be explosion-proof by the weighing apparatus having a pressure-resistant housing or a pressure-resistant enclosure, wherein the housing or the enclosure must also withstand the pressure of an explosive mixture that might be present in the housing and prevent the explosion from being transmitted outwardly. In the process, it must also be prevented that components of the housing or the enclosure are flung off from the housing like projectiles in the event of an explosion of a mixture in the interior of the housing. Furthermore, in the event of an explosion inside the housing or the enclosure, it must be ensured that no ignition occurs in the environment in order to prevent an explosion from also being caused outside the housing in the event that an explosion-endangered atmosphere is present outside the housing or the enclosure. For example, if openings, such as passage openings for moveable components, are provided in the housing, they must be designed in such a way that hot particles produced by an explosion are not able to exit through these types of openings and are not adequate enough to cause an ignition of an explosion-endangered atmosphere that is possibly present in the exterior space. The exiting gas in this case may also not exceed a specific maximum temperature. In order to ensure this, an opening, for example an annular gap around an element fed through a housing wall can be dimensioned in such a way that there is a sufficiently small cross-section (the exit direction of the gas runs perpendicular to this cross-section). In addition, the exit opening must have a predefined minimum length (as viewed in the exit direction) so that the exit temperature of the gas does not exceed a predefined maximum value.

These measures for an explosion-proof design of a weighing apparatus, however, require a correspondingly high structural expense, which increases the construction size for the housing of the apparatus and its weight and is also associated with corresponding manufacturing costs. The provision of a static or dynamic protective gas atmosphere or the dynamic supply of ambient air (that is not explosion-endangered) likewise requires a corresponding expense for the protective gas supply and leads to high operating costs.

Producing a largely force-shunt-free electrical connection between stationary components inside the housing of this type of a weighing apparatus and the electric drive of the conveyor belt is known in that corresponding lines are directed through the interior of the load receptor that is fed through the housing wall. Provided at the lower end region of the load receptor, which is located in the housing of the weighing apparatus, is an electrical circuit board, which has contacts that are connected to the ends of the lines fed through the load receptor. Provided in the housing is another circuit board embodied to be stationary, which also has contacts that are connected to corresponding supply lines or control lines, which come from the corresponding components inside or even outside of the housing. Both circuit boards respectively have a bridge contact for each line, wherein respectively two bridge contacts assigned to each other are connected via an adequately flexible, normally short, electric bridge in the form of an electrical conductor. Said electrical conductors are normally not isolated or at most isolated with a thin coating layer in order to ensure an adequate flexibility. In this way, a sufficient movability of the load receptor is guaranteed with respect to a stationary region of a suitable measuring sensor with a simultaneously low force shunt.

The measuring sensor can be a weighing sensor for example, which functions in accordance with the principle of electrodynamic force compensation. In this case, only extremely minor or infinitesimally small displacements are required between the load receptor and the land. Consequently, the electrical bridges can be embodied to be very short.

However, in this case it would be necessary to design the entire housing of the weighing apparatus to be explosion-proof in order to guarantee explosion protection. This is because the manner of signal transmission or transmission of the electrical drive power through the load receptor, which was explained in the foregoing, harbors the risk that a short circuit, an electric arc, or terminal discharges, for example, could occur between the bridge conductors in the event of a malfunction, which would ignite an explosion-endangered atmosphere located in the housing. This is associated in turn with a corresponding expense.

### SUMMARY OF THE INVENTION

Proceeding from said state of the art, the object of the invention is to create a current transmission device for a force measuring apparatus, in particular a weighing apparatus, with which the force measuring apparatus is embodied to be explosion-proof and therefore can be used in an explosion-endangered atmosphere, and which can be realized in a simple and cost-effective manner. Furthermore, the object of the invention is to create a force measuring apparatus, in particular a weighing apparatus, having this type of current transmission device.

Any apparatus for recording a force weight is designated as a weighing apparatus in the following.

The invention attains this object with the features of independent claims 1 and 15.

The invention proceeds from the realization that the explosion protection for a force measuring apparatus that has a housing can thereby guarantee that the entire housing does not have to satisfy the requirements of explosion protection, but merely a current transmission device according to the invention arranged in the housing of the force measuring apparatus or connected outside to the housing of the force measuring apparatus. Such a current transmission device is used in the process for the line-based transmission of electrical energy, in particular for the energy supply of any components (e.g., of an electric drive) and/or for the line-based communication (i.e., for the transmission of electrical signals).

In this case, the current transmission device according to the invention has a pressure-resistant housing with a housing wall, wherein the housing can be fixedly connected mechanically to the base region of the force measuring apparatus. The base region of the force measuring apparatus can be for example the housing of the force measuring apparatus. Furthermore, the current transmission device has a connecting element, which, at an outer end region that protrudes from the housing, can be fixedly connected mechanically to the moveable region of the force measuring apparatus in an operating state. In this case, for example it can be a region of a load receptor protruding from the housing of the force measuring apparatus or a component connected thereto, for example a load plate situated outside of the housing. In the case of the example explained in the foregoing of a weighing apparatus having a housing and a conveyor belt located outside of the housing, which conveyor belt, as an initial load, acts on a force transducer (for example a weighing cell) in the housing, the conveyor belt can be arranged on this type of load plate.

The connecting element protruding from the housing of the current transmission device is embodied in such a way that, in an operating state, it passes through the housing wall in a contactless and ignition-safe manner. The term “ignition-safe manner” in this case means that the passage of the connecting element through the wall of the housing is designed so that a protection against explosion is guaranteed (as the case may be, taking relevant regulations and, if applicable, also various classes of explosion protection into consideration).

The connecting element of the current transmission device in this case is embodied as a moveable cable pass-through, wherein a first cable with at least one electric line at the outer end region (i.e., outside of the housing of the current transmission device) is directed into the connecting element and passes through it. The cable is directed into the housing at an inner end region of the connecting element, which protrudes into the housing. The cable is thereby directed in the connecting element in the housing, wherein the passage of the cable through the connecting element must be designed to at least be safe from ignition. For example, the cable can be directed through a recess in the connecting element and be glued in this recess. Instead of gluing, the cable can also be clamped in this recess of the connecting element using suitable structural measures. In addition, it is possible to free individual strands of the cable (designated as lines in the following) in a specific axial region of a sheath of the cable and glue them in a recess of the connecting element. In this way, it is possible to achieve that an overpressure developing inside of the housing (in the case of an explosion) is not able to inflate the cable sheath outside of the housing and possibly bring it to an explosive bursting, wherein in this case even the risk of an ignition may exist.

It is of course also possible, instead of a single cable, to direct multiple cables with respectively a single line or a plurality of lines (then designated as a cable) through the connecting element in the housing of the current transmission device.

The passage of the at least one cable through the connecting element must also be pressure resistant in this case so that, for the case that an overpressure is produced in the housing by an explosion, the recess for the cable in the connecting element does not rupture. In this case, an ignition could again occur or parts of the cable or components for the passage of the cable could detach and be flung off.

Furthermore, the housing of the current transmission device has a housing-affixed cable feedthrough, which is embodied for the pressure-resistant and ignition-proof passage of a second cable having at least one electric line through the housing wall. In this case as well, a plurality of cables each with a single line can be used instead of a single cable. The foregoing comments about the passage through the connecting element apply in an analogous manner to the passage through the housing.

At the second end region of the connecting element, a moveable contact device fixedly connected mechanically to said element and, in the housing, a housing-affixed contact device fixedly connected mechanically to the housing are provided, wherein between the moveable and the housing-affixed contact device[s] at least one flexible electric contact bridge is embodied.

The at least one lint of the first cable is connected mechanically and electrically to the moveable contact device and the least one line of second cable is connected mechanically and electrically to the stationary contact device in such a way that, via the at least one contact bridge, an electrical and mechanical contact is formed between the at least one line of the first cable and the at least one line of the second cable.

This at least one flexible electrical contact bridge is designed so that the thereby generated force shunt, which is produced through the first and the second cable between the base region and the moveable region of a force measuring apparatus having such a current transmission device, is smaller than a predetermined threshold value. This threshold value can of course be selected as a function of the required measuring accuracy of the force measuring apparatus. The electric contact bridge can be embodied for example as a thin gold band or from a plurality of individual fine wires.

According to an embodiment of the invention, the current transmission device is embodied in such a way that the connecting element is embodied as an essentially cylindrical element and that, in a region of a pass-through opening for the connecting element, the housing wall has a predetermined thickness and the pass-through opening has a predetermined cross-section, which are selected so that, in the operating state, an ignition-safe annular gap is formed between the connecting element and an inner wall of the pass-through opening.

An ignition-safe annular gap thereby requires that its cross-section (as viewed in the direction of a longitudinal axis of the connecting element) and its length are determined so that even in the case of an explosion in the interior of the housing, it is ensured that an ignition does not occur in the area surrounding the housing, even if an explosion-endangered atmosphere exists therein. In doing so, the cross-section of the annular gap along the longitudinal axis of the connecting element can also change.

In a further embodiment, the housing can have a housing cover detachably connected to the housing, which is embodied such that the housing cover interacts with an engagement region extending into the interior of the housing with at least one stop shoulder on the outer circumference of the connecting element in such a way that a limit stop is produced with respect to the movement of the connecting element at least with respect to a movement of the connecting element in a movement direction out of the housing.

For this purpose, the housing cover can have a preferably circumferential flange extending into the housing, which flange forms the engagement region.

The at least one stop shoulder can be formed by a recess, for example a groove, in the outer circumference of the connecting element.

In the event of an explosion in the interior of the housing of the current transmission device, such a limit stop prevents the connecting element from being flung out of its receptacle opening like a projectile.

In addition to the stop shoulder limiting this movement out of the housing, a further stop shoulder can be provided, which prevents the connecting element from moving too far into the housing. In this way, a destruction of the at least one contact bridge or even the moveable or housing-affixed contact device can be prevented in particular.

For example, a groove in the outer circumference of the connecting element can realize both stop shoulders at the same time.

For a simpler mounting of the current transmission device, an annular mounting element can be provided, which encompasses the connecting element and is embodied on it to be displaceable in the direction of a longitudinal axis of the connecting element between an adjustment position and an operating position. Furthermore, for this purpose, the pass-through opening for the connecting element can be embodied, in relation to the housing, at an outwardly facing region, as an engagement region for an annular mounting element. In this case, the mounting element and the engagement region can be embodied so that and, when the mounting element is located in the adjustment position, they interact such that the connecting element is positioned in the housing in such a way that, with the exception of the engagement region, the ignition-safe annular gap between the connecting element and an inner wall of the pass-through opening is formed. In said adjustment position, the connecting element with the moveable region of a force measuring apparatus and the housing of the current transmission device with the base region of the force measuring apparatus can be mechanically connected in such a way that, after the mounting element and the engagement region are disengaged, an (essentially exclusively axial) movement of the connecting element in the pass-through opening is facilitated. In this operating position, the mounting element then releases the connecting element, i.e., the connecting element contactlessly passes through the pass-through opening.

Consequently, a very simple mounting of the current transmission device on or in a force measuring apparatus can occur, wherein the highly accurate adjustment of the connecting element with respect to the housing of the current transmission device can be ensured.

According to an embodiment of the invention, the mounting element can be embodied so it can be locked on the connecting element in the operating position and/or the adjustment position. As a result of the locking in the operating position, the mounting element can remain on the connecting element in the operating state, without it being able to interfere with the free mobility of the connecting element in the pass-through opening.

The mounting element can also be embodied such that it co-forms a labyrinth seal in the operating position, i.e., becomes part of a labyrinth seal, which protects the annular gap in particular against the penetration of water, dust, or other particles.

According to another embodiment of the invention, the mounting element is encompassed by a ring element, which can be moved from a mounting position into a working position, wherein, in the working position, the ring element is positioned offset with respect to the mounting element in the direction of the housing and forms the labyrinth seal with the mounting element and the housing.

The ring element can also be locked in the working position with respect to the mounting element and therefore also with respect to the connecting element. Said working position can be selected so that the lower front side of the ring element, i.e., the front side of the ring element facing the outer side of the housing forms a stop for the movement of the connecting element into the housing.

Moreover, the housing can have a projecting flange surrounding the pass-through opening for co-forming the labyrinth seal, which flange is preferably encompassed by the ring element, wherein an annular gap is formed between an inner wall of the ring element and an outer wall of the flange. This annular gap can also form a part of the labyrinth seal.

According to a further embodiment, the moveable contact device and the housing-affixed contact device are each embodied as a printed circuit board. The at least one flexible electric contact bridge between the relevant contacts of the printed circuit boards can be embodied as a flexible electrical conductor, in particular as a metallic conductor, for example a gold band.

In order to simplify the assembly of the current transmission device according to the invention, the printed circuit boards forming the moveable contact device and the housing-affixed contact device can be mechanically connected to each other in a mounted state. Therefore, after inserting the connecting element into the housing, the two connected printed circuit boards can be connected for example to the housing or to the inner end of the connecting element. The connecting element can be situated thereby in a position in which the mounting element in its adjustment position engages on the connecting element in the entrance area of the housing and thereby positions the connecting element with respect to the housing so that the connecting element contactlessly passes through the housing. Then the connection between the two printed circuit boards can be lifted, without there being a risk that the at least one sensitive contact bridge is destroyed.

The printed circuit boards can thereby be connected via separating points, wherein a one-piece production of the printed circuit boards is possible. The separating points are thereby defined by a correspondingly narrow or thin selected part of the printed circuit boards.

This makes it possible for the current transmission device according to the invention to create a force measuring apparatus for the use in an explosion-endangered atmosphere, which has a simple and cost-effective structure and in which an electric line connection is embodied between the two regions of the force measuring apparatus that can be moved relative to each other, which generates merely an extremely low force shunt. The current transmission device according to the invention is embodied to be modular in this case and can also be used for a relatively simple retrofitting or upgrading of an already existing force measuring apparatus. In addition, because of the modular embodiment, use for a wide variety of models of force measuring apparatuses is possible. The current transmission device according to the invention can thereby accommodate other electrical components that are not embodied to be intrinsically safe, which are required for the force measuring apparatus and without the current transmission device according to the invention would have to be arranged in the housing of the force measuring apparatus (wherein in this case without the use of the current transmission device according to the invention, the entire housing of the force measuring apparatus would have to be designed to be explosion-proof).

### BRIEF DESCRIPTION OF THE DRAWINGS

Further embodiments of the invention are specified in the dependent claims. The invention will be described in greater detail in the following based on an exemplary embodiment depicted in the drawing, without this exemplary embodiment being regarded as an limitation of the basic core ideas of the invention explained in the foregoing. The drawing shows the following:

FIG. 1 A perspective view of a weighing apparatus having a housing, a load plate arranged outside of the housing, and a force transducer arranged in the housing, the load introduction of which is mechanically coupled to the load plate;

FIG. 2 A perspective view of the weighing apparatus according to FIG. 1 without the lateral housing wall with a current transmission device according to the invention;

FIG. 3 A partial cross-sectional side view of the current transmission device according to FIG. 2;

FIG. 4 A perspective view of the connecting elements of the current transmission device according to FIG. 3 with a moveable contact device fastened thereto; and

FIG. 5 A perspective view of the lateral housing cover of the housing of the current transmission device according to FIG. 3.

### DETAILED DESCRIPTION OF THE PREFERRED EMBODIMENTS

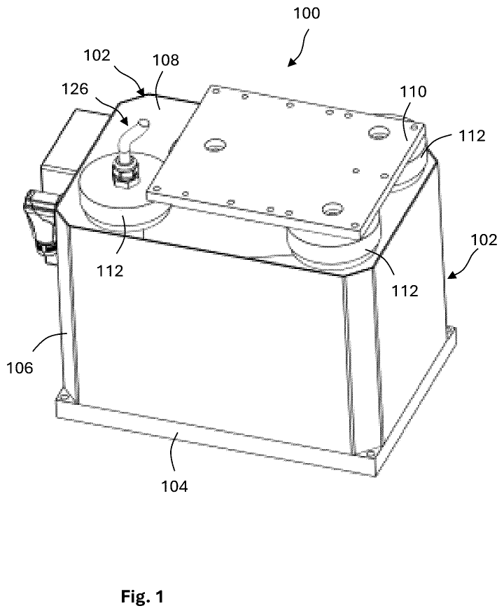

FIG. 1 shows, in a perspective view, a force measuring apparatus in the form of a weighing apparatus 100 having a housing 102, which has a base plate 104, a circumferential side wall 106, and an upper housing wall 108. A load plate 110 is mechanically connected to three supporting elements, which are directed through the upper housing wall 108, wherein the supporting elements contactlessly pass through the upper housing wall 108. The corresponding breakthroughs in the upper housing wall 108 and/or the annular gaps, which are formed by the inner walls of the breakthroughs and the outer walls of supporting elements passing through these, are respectively “sealed” by means of a labyrinth seal 112, wherein sealing in this case means that a ring-shaped annular gap that also extends cross-sectionally in a meander-like fashion, which is embodied by each labyrinth seal, prevents the penetration of water, dust, and other particles. The passage of the supporting elements remains contactless in the process and does not produce any force shunt whatsoever.

Provided on the left side of the housing wall 106 in FIG. 1 is a bushing arrangement 114, via which the weighing apparatus 100 can be supplied with electrical energy and via which a unidirectional or bidirectional communication connection can be established between the weighing apparatus 101 and a superordinate unit, for example an external control unit (not shown).

The housing 102 of the weighing apparatus 100 is not designed to be explosion-proof. Despite this, the weighing apparatus 100, as viewed as a whole, should be embodied so that it can be operated in an explosion-endangered atmosphere taking corresponding regulations into account.

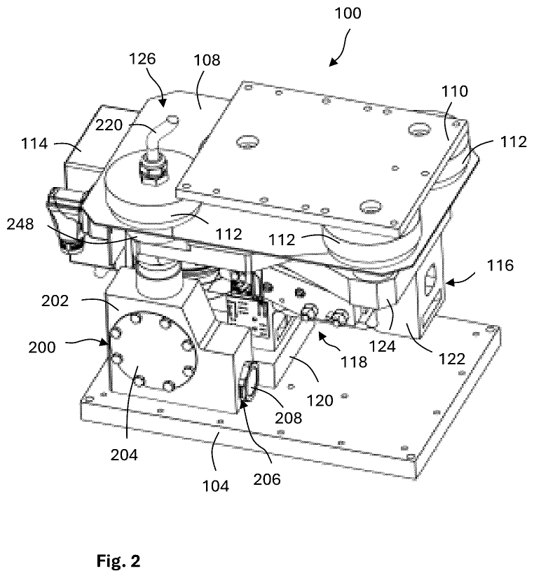

FIG. 2 shows the weighing apparatus 100 from FIG. 1 without the circumferential side wall of the housing 102. As this figure shows, a force transducer 116 is provided in the interior of this housing 102, which functions in accordance with the principle of electromagnetic force compensation in the depicted exemplary embodiment. The force transducer 116 has a basic body 118, which encompasses, on the one hand, a base part 120 and, on the other hand, a load introduction region 122 connected to the base part 120 via a lever mechanism. The load introduction region 122 has on its upper side a carrier plate 124, which for its part is connected in turn to the supporting elements described in the foregoing, which supporting elements are fed contactlessly through the upper housing wall 108. The carrier plate 124 can be screwed to the load introduction region 122 for example.

As a result, the force transducer 116 can record the force weight that acts on the load plate 110. The load plate 110 can be connected to and loaded with a further apparatus, such as a conveyance device (not shown), for example an electrically driven conveyor belt. The electric drive of the conveyor belt must be supplied in the process with electrical energy. In such a case, it is necessary to establish a communication connection between the weighing apparatus 100 and/or an external unit connected to the weighing apparatus via the bushing arrangement 114. Normally, a cable connection between the weighing apparatus and the further apparatus that is fixedly connected mechanically thereto is used for this purpose. The term “cable connection” is used here in the sense of any line-based-embodied connection for the transmission of electric currents (independent of what purpose the currents are used for). FIGS. 1 and 2 partially show a cable 126 of this sort of cable connection, wherein only the portion of the cable 126 that is fed through the upper housing wall 108 of the housing 102 of the weighing apparatus 100 is depicted.

FIG. 2 shows a current transmission device 200 arranged in the interior space of the housing 102, which current transmission device has a housing 202. The housing 202 has a closure cover 204 provided on the front side wall, which is connected to the housing 202 with a plurality of screws. On the right side wall thereof, the housing 202 has a housing-affixed cable feedthrough 206, wherein FIG. 2 shows only a connecting part 208 connected to the housing without depicting a cable fed through the connecting part 208 and retained therein. This cable directed into the housing 202 of the current transmission device 200 can be connected for example to the bushing arrangement 114 so that, due to a connection of the bushing arrangement 114, a correspondingly line connection can be established from an external unit (not shown) to the current transmission device 200 and from said device to the unit connected to the load plate 110, for example a conveyor belt.

The current transmission device 200 makes it possible for a cable (not shown) directed on the side wall of said device via the housing-affixed cable feedthrough 206 into the housing 202 to be connected to the cable 126 in such a way that only a very low force shunt is induced with respect to the parts of the force transducer 116 that are moveable relative to each other (and therefore also with respect to the parts of the weighing apparatus 100).

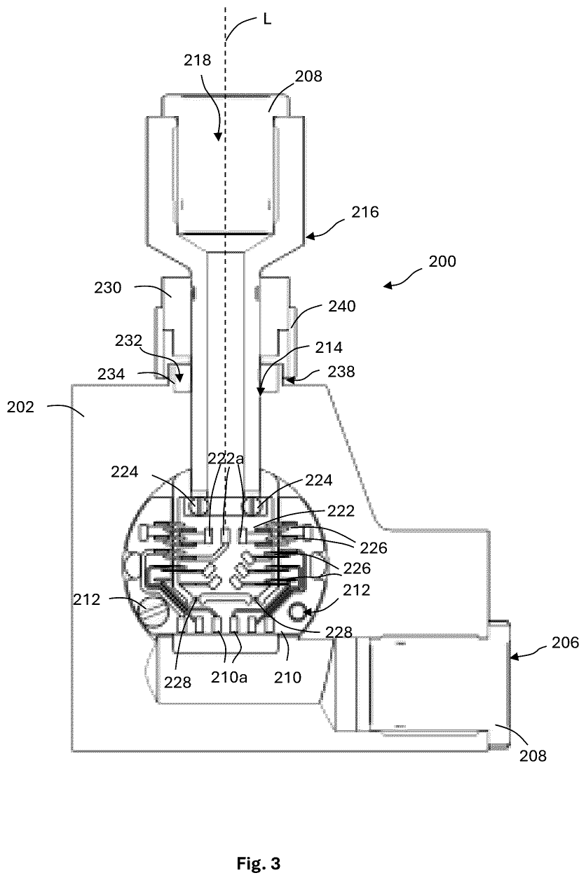

FIG. 3 shows a sectional view of the current transmission device 200 in a vertical median plane (in relation to the depiction in FIG. 2). First of all, this figure shows that the housing 202 has very thick walls, which produces the pressure resistance of the housing. The connecting part 208 of the housing-affixed cable feedthrough 206 is screwed into the right side wall of the housing, wherein of course said screw connection must also be embodied to be pressure resistant in order to prevent the connecting part 208 from being flung out of the housing 202 like a projectile in the event of an explosion inside the housing 202. The cable (not shown), which is fed through the connecting part 208, must be connected to the connecting part 208 in at least an ignition-proof manner. As already explained in the foregoing, this can be accomplished by a clamping mechanism (not shown in more detail) or by gluing and/or casting. Because the cable normally has a plurality of lines combined therein, the sheath in an axially inner region of the connecting part 208 can also be removed in order to improve the connection between the cable and the connecting part 208, so that the individual lines, respectively taken separately, can be connected to the connecting part 208, for example by gluing or casting.

Arranged in the interior space of the housing 202 is also a housing-affixed contact device 210, which can be screwed to the housing, for example, by means of two screws 212 (FIG. 2 shows only the left screw 212). The housing-affixed contact device 210 has connection contacts 210a, which can be connected to the ends of the lines contained in the cable. This can be accomplished by soldering or any desired clamping mechanism.

Embodied in the upper wall of the housing 202 is a pass-through opening 214, through which a connecting element 216 extends. The connecting element 216, at least in an operating state, in which the connecting element 216 is connected to the moveable part of the weighing apparatus 100, in particular the carrier plate 124 and therefore also the load plate 110, is fed through the pass-through opening 214 in a contactless and ignition-safe manner. For this purpose, the cross-section of the pass-through opening 214 is dimensioned with respect to the cross-section of the connecting element 216 (in the region of the pass-through opening 214) so that, in the operating state, there is an ignition-safe annular gap between the inner wall of the pass-through opening 214 and the outer wall or the outer circumference of the connecting element 216. The operating state therefore naturally requires a sufficiently exact positioning of the connecting element 216 with respect to the housing 202 and therefore the pass-through opening 214.

As FIG. 3 shows, the connecting element 216, at least in the region with which the connecting element 216 passes through the pass-through opening 214, can be embodied to be cylindrical, in particular circular cylindrical. This thereby produces a simple structural design, since the pass-through opening 214 can be designed as a borehole.

In its upper region, the connecting element 216 can have a receptacle region for another connecting part 208, which can have the same structural design as the connecting part 208 of the housing-affixed contact device 210. A simple structural design is thereby achieved. Of course, this region of the connecting element 216 can also be embodied in any other suitable manner however. In this case as well, the connecting part 208 is held in the connecting element 216 in a pressure-resistant manner.

The connecting element 216 is embodied as a whole as a cable pass-through, and, for this purpose, has a recess 218 passing through the entire length of the connecting element 216, wherein the upper region of the recess 218 is embodied to receive the connecting part 208 with an internal thread, which interacts with an external thread of the connecting part 208.

The connecting part 208, which is screwed into the upper region of the connecting element 216, receives a cable 220 of the cable connection 126 (FIG. 2) and directs it into the recess 218 in at least an ignition-safe manner. Of course, the cable 220 can also have a plurality of lines, which can also be fixed individually in the connecting part 208, as described in the foregoing.

The cable 220 and/or the relevant lines are directed through the recess 218 and protrude with their inside ends into the interior space of the housing 202. The inside region of the connecting element 216 also protrudes into the interior space of the housing 202 so that, as shown in FIG. 3, a moveable contact device 222 can be fastened on the inside end of the connecting part 216. This fastening can in turn be accomplished by means of screws 224.

The moveable contact device 222 also has connection contacts 222a, which are connected to the ends of at least one line (not shown) contained in the cable 220. The connection can also be accomplished by soldering or suitable clamping mechanisms for example. The moveable contact device 222 is therefore moveable together with the connecting element 216, wherein relative movements can be executed with respect to the housing 202. The path of movement depends in this case on the embodiment of the force transducer 116. If it is embodied as a force transducer in accordance with the principle of electromechanical force compensation, then at most infinitesimally small paths of movement are executed since this measuring principle is based on keeping the load receptor in a predefined position as much as possible, wherein the current required for this represents a measure for the force weight to be detected.

The connection contacts 210a of the housing-affixed contact device 210 and the connection contacts 222a of the moveable contact device 222 are connected via contact bridges 226, wherein one contact bridge 226 each connects one connection contact 210a to an associated connection contact 222a. Correspondingly, one line of the cable directed into the housing 202 by means of the cable feedthrough 206 is connected to an associated line of the cable directed into the housing 202 by means of the connecting element 216. The contact bridges 226 consist of very flexible electrical conductors, for example gold wires or gold bands, for the most extensive reduction of a force shunt possible. They can be connected to the connection contacts 222a and/or 210a by bonding, soldering or the like. If a contact bridge 226 is supposed to be embodied to carry higher current strengths then respectively two or more wires can also be connected to the relevant connection contacts.

The contact devices 210 and 222 can be embodied as printed circuit boards, as shown in FIG. 3, wherein the connection contacts 210a and/or 222a can be embodied in the form of corresponding conductor paths or conductor path regions. Connection contacts 210a and 222a can also respectively have initial regions and end regions, which can be connected via one or more conductor strips. Therefore, the regions in which the ends of the contact bridges are connected to the connection contacts can be at a different location than the regions of the connection contacts that are connected to the corresponding ends of the lines that are directed in the cables.

In the case of the embodiment depicted in FIG. 3, the printed circuit boards of the contact devices 210 and 222 are still connected to each other via connecting bridges 228. This is because the printed circuit boards of the contact devices in this exemplary embodiment were produced as a single printed circuit board, which has a first region, which forms the contact device 210, and a second region, which forms the contact device 222. The assembly of the current transmission device 200 is hereby simplified. For example, the still one-piece circuit board, which forms the contact devices 210 and 222, can be inserted first of all into the housing 202 and be fastened with the screws 212. Then, the ends of lines of the cable, which is directed into the housing by means of the cable feedthrough 206, can be connected to the connection contacts 210a. Then, the connecting element 216 can be inserted into the pass-through opening 214 until the inside end of the connecting element 216 is positioned with respect to the circuit board in such a way that it can be connected to the connecting element 216 with the screws 224. In this state, the cable 220 still does not have to be screwed into the connecting part 208 in the upper region of the connecting element 216. However, this can also be the case.

In this mounted state of the connecting element 216, it is not guaranteed, however, that the connecting element 216 protrudes contactlessly through the pass-through opening 214 since the relevant annular gap has extremely small dimensions and just the fastening of the connecting element 216 via the circuit board forming the contact devices 210 and 222 does not suffice for this type of an exact positioning.

For the purpose of an exact positioning of this type, a mounting element 230 embodied to be ring-like is provided on the connecting element 216, which mounting element encompasses the connecting element and can be displaced axially on the connecting element 216 (in the direction of a longitudinal axis L of the connecting element). The mounting element 230 encompasses the connecting element 216 without play, but can be displaced axially so that when the mounting element 230 is fixed, the connecting element 216 that is guided therein is also positioned exactly in the relevant position.

As FIG. 3 shows, the housing 202 has, in the region of the pass-through opening 214 at the upper housing wall, an engagement region 232, which is embodied in such a way that it interacts with a lower region of the mounting element 230 for an exact positioning of the mounting element 230 and therefore of the connecting element 216. To this end, the engagement region 232 can have a circumferential ring shoulder 234 for example, which has a vertically running inner wall, which interacts with the vertical outer wall of the lower region of the mounting element 230. This outer wall in the lower region of the mounting element 230 and the inner wall of the ring shoulder 234 can be embodied to be exactly coaxial to the longitudinal axis L. The ring shoulder or its (vertical) inner wall that runs coaxially to the longitudinal axis L can be embodied here in a region of the housing wall projecting with respect to the surface of the upper housing wall and/or in a region of the housing wall inwardly offset with respect to the surface. As a result, an exact positioning of the connecting element 216 can be achieved in that the lower region of the mounting element 230 is brought into engagement with the engagement region 232.

Instead of a circumferential ring shoulder, it is also possible of course to provide distributed elements or regions only in sections around the circumference of the mounting element 230, which elements or regions produce an exact positioning of the connecting element 216 in a analogous manner.

The mounting element 230 can also be embodied so it can be locked with respect to the connecting element 216, for example by means of one or more grub screws 236, which extend inwardly in the direction of the connecting element 216 perpendicular to the longitudinal axis L, in the wall of the mounting element 230.

Therefore, the assembly of the current transmission device 200 described in the foregoing can be supplemented as follows: After connecting the circuit boards that form the contact devices 210 and 222 to the connecting element 216, the mounting element 230 can be shifted downwardly in the engagement region 232 and be locked in this position. Then, the connecting bridges 228 can be separated and the closure cover 204 can be inserted and screwed to the housing 202. When pre-assembled in this manner, the current transmission device 200 can be stored, packed, or even installed in a weighing apparatus 100.

The current transmission device 200 can be provided at every suitable position inside the housing 102, for example near the attachment point of the force transducer on the base plate 104 or in the vicinity of the load introduction region 122 or in the region of a rotary joint of a lever mechanism of the force transducer 116.

In order to safeguard the ignition-safe annular gap between the connecting element 216 and the inner wall of the pass-through opening 214 against the penetration of particles, water, or the like, the mounting element 230 can form a labyrinth seal 238 together with the engagement region 232. In doing so, the lower front side of the mounting element 230 in particular can act a boundary wall for the labyrinth seal 238.

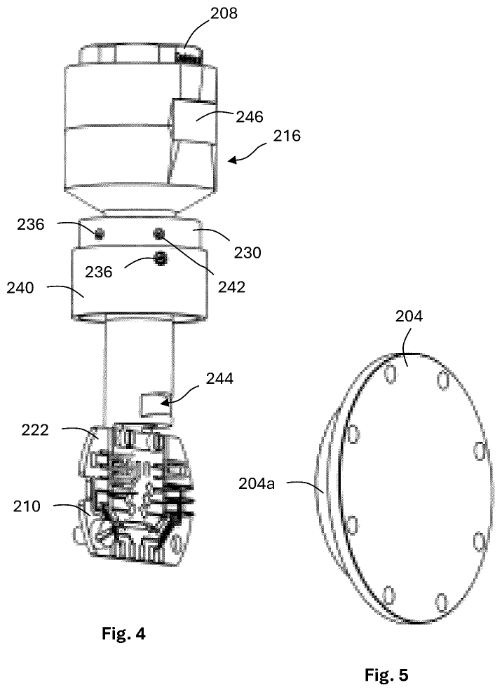

As can be seen in FIG. 3, the mounting element 230 can be encompassed by a ring element 240, which also contributes to the formation of the labyrinth seal 238. The ring element 240 has an inner cross-section, which essentially corresponds to outer cross-section of the mounting element 230 so that the ring element 240 essentially tightly encloses the mounting element 230. The ring element can also be fixed on the mounting element 230 by means of a grub screw 236. In order to achieve an axial positioning of the ring element 240 on the mounting element 230, the mounting element 230 can have two recesses 242, in which the grub screw 236 in the ring element 240 can engage. A first recess 242, which is shown in FIG. 4, can serve to lock the ring element 240 in an upwardly shifted state on the mounting element 230 in such a way that the connecting element 230 is able to engage in the entrance region 232. In an downwardly shifted state, as depicted in FIG. 4, the grub screw 236 in the ring element 240 engages in another recess in the mounting element 230 in order to lock the ring element in a downwardly shifted position on the connecting element 216. In this position, the labyrinth seal 238, as shown in FIG. 3, is formed by the engagement region 232, the ring shoulder 234, the lower front side of the mounting element 230, and the ring element 240.

In this downwardly shifted working position, the lower front side of the ring element 240 facing the upper housing wall can also act as a limit stop in order to limit an axial movement of the connecting element 216 into the housing 202.

This type of limitation of the displacement path for the connecting element 216 can also be brought about in that the closure cover 204 has a flange 204a protruding essentially horizontally into the housing interior, which flange engages in a groove 244 of the connecting element provided in the circumference of the region extending into the interior of the housing. The areas of the groove 244 that run horizontally in this case have an axial distance, which, with regard to the thickness of the flange 204a, is selected so that the connecting element 216 is able to execute a sufficiently large axial displacement movement.

The installation of the current transmission device 200 in a force measuring apparatus, for example in the form of the weighing apparatus 100, can take place as described in the following: The current transmission device 200, which is pre-assembled as described above, is connected to the stationary region of the weighing apparatus 100 with the mounting element 230 that is engaged in the engagement region 234 (in an adjusted and possibly locked state of the current transmission device 200). For this purpose, the housing 202 can be connected to the base plate 104 of the housing 102 of the weighing apparatus 100. This can be accomplished for example by screwing or the like. To connect the connecting element 216 to the load receptor and/or the load introduction region of the force transducer 116, an upper head region of the connecting element 216, which is essentially designed to be circular cylindrical, can, as shown in FIG. 2, have two surfaces 246 that run parallel to each other in a suitable axial region. With this axial region, it is possible for the head region of the connecting element 216 to engage in a slot of a region in the carrier plate 124 that is embodied to be fork-shaped. A nut 248 can then be screwed on the upper head region of the connecting element in order to fixedly connect the connecting element 216 mechanically to the carrier plate 124. Then, the upper housing wall 108 of the housing 102 can be positioned, wherein the upper region of the connecting element 216 and three other elements extending upwardly from the carrier plate 124 pass through the upper housing wall 108. Then, the labyrinth seals 112 can be established both in the region of the pass-through of the upper region of the connecting element 216 through the upper housing wall 108 as well as in the region of the other elements, and the load plate 110 can be mounted. In a next step, the further apparatus, for example the conveyor belt, can be positioned on the load plate and be connect thereto. The cable 220 can be connected to an electrical device of the further apparatus, for example the drive of the conveyor belt.

After this assembly process, the mounting element 230 can be shifted into its upper position and be locked in said position. Finally, the ring element 240 can be brought into its lower position and be locked in said position. Finally, the cable guided out of the housing 202 of the current transmission device 200 by means of the housing-affixed cable feedthrough 206 can be connected to the bushing arrangement 114. Once the side wall of housing is attached, the assembly process is concluded.

It should be pointed out that one or more steps of the assembly process described above can of course be executed in a different sequence. For example, the housing 102 can also be embodied as a pull-over housing, i.e., the upper housing wall 108 and the side wall 106 are embodied to be one piece.

The modularly designed current transmission device 200 can therefore be retrofitted in a simple manner even in the case of already existing force measuring apparatuses using minor modification measures to design the relevant force measuring apparatus to be explosion-proof or to achieve an explosion protection. Due to the modular design, one and the same current transmission device 200 can also be used for a wide variety of models of force measuring apparatuses.

Finally, it must be noted that, in addition to the electrical connection with low force shunt described above, other electrical or electronic components that are not designed to be intrinsically safe can also be arranged in the housing 202 so that critical components that can cause an ignition of a explosion-endangered atmosphere inside of the housing 102 are no longer accommodated in the housing 102 of the weighing apparatus 100.

The entire current transmission device 200 can also be arranged outside of the housing of a force measuring apparatus, for example on the same basic frame or be connected to the housing of the force measuring apparatus.

### LIST OF REFERENCE NUMBERS

100 Weighing apparatus
102 Housing
104 Base plate
106 Circumferential side wall
108 Upper housing wall
110 Load plate
112 Labyrinth seal
114 Bushing arrangement
116 Force transducer
118 Basic body
120 Base part
122 Load introduction region
124 Carrier plate
126 Cable connection
200 Current transmission device
202 Housing
204 Closure cover
206 Cable feedthrough
208 Connecting part
210 Housing-affixed contact device
210a Connection contact
212 Screw
214 Pass-through opening
216 Connecting element
218 Recess
220 Cable
222 Movable contact device
224 Screw
226 Contact bridge
228 Connecting bridge
230 Mounting element
232 Engagement region
234 Ring shoulder
236 Grub screw
238 Labyrinth seal
240 Ring element
242 Recess
244 Groove
246 Surface
L Longitudinal axis

1. A current transmission device for a force measuring apparatus, in particular a weighing apparatus, wherein the force measuring apparatus (100) has a housing (102) and a base region as well as a moveable region, which can be moved relative to each other,
(a) having a pressure-resistant housing (202) with a housing wall, which housing can be fixedly connected mechanically to the base region of the force measuring apparatus (100), and a connecting element (216), which, at an outer end region that protrudes from the housing (202), can be fixedly connected mechanically to the moveable region of the force measuring apparatus (100) in an operating state,
(b) wherein the connecting element (216) is embodied in such a way that, in an operating state, it passes through the housing wall in a contactless and ignition-safe manner,
(c) wherein the connecting element (216) is embodied as a moveable cable pass-through, wherein a first cable (220) having at least one electric line is directed at the outer end region into the connecting element (216), passes through it, and is directed at an inner end region of the connecting element (216) into the housing (202),
(d) wherein the housing (202) has a housing-affixed cable feedthrough (206), which is embodied for the pressure-resistant and ignition-proof passage of a second cable having at least one electric line through the housing wall,
(e) wherein, at the inner end region of the connecting element (216), a moveable contact device (222) fixedly connected mechanically to said element and, in the housing (202), a housing-affixed contact device (210) fixedly connected mechanically to the housing are provided, wherein between the moveable (222) and the housing-affixed (210) contact device[s] at least one flexible electric contact bridge (226) is embodied and
(f) wherein the at least one line of the first cable is mechanically and electrically connected to the moveable contact device (222) and the at least one line of the second cable is mechanically and electrically connected to the stationary contact device (210) in such a way that, via the at least one contact bridge (226), an electrical contact is formed between the at least one line of the first cable and the at least one line of the second cable, and
(g) wherein the current transmission device (200) is embodied in such a way that it can be mounted in a housing (102) or externally on a housing (102) of the force measuring apparatus (100).

2. The current transmission device according to claim 1, characterized in that the connecting element (216) is embodied as an essentially cylindrical element and that, in a region of a pass-through opening (214) for the connecting element (216), the housing wall has a predetermined thickness and the pass-through opening (214) has a predetermined cross-section, which are selected so that, in the operating state, an ignition-safe annular gap is formed between the connecting element (216) and an inner wall of the pass-through opening (214).

3. The current transmission device according to claim 1, characterized in that the housing (202) has a housing cover (204) detachably connected to the housing, which is embodied such that the housing cover (204) interacts with an engagement region (204a) extending into the interior of the housing with at least one stop shoulder on the outer circumference of the connecting element (216) in such a way that a limit stop is produced with respect to the movement of the connecting element (216) at least with respect to a movement of the connecting element (216) in a movement direction out of the housing (202).

4. The current transmission device according to claim 3, characterized in that the housing cover (204) has a preferably circumferential flange (204a) extending into the housing (202), which flange forms the engagement region.

5. The current transmission device according to claim 3, characterized in that the at least one stop shoulder is formed by a recess (218) in the outer circumference of the connecting element (216).

6. The current transmission device according to claim 2, characterized in that
(a) the pass-through opening (214) for the connecting element (216) is embodied, in relation to the housing (202), at an outwardly facing region, as an engagement region (232) for an annular mounting element (230), which encompasses the connecting element (216) and is embodied on it to be displaceable in the direction of a longitudinal axis (L) of the connecting element (216) between an adjustment position and an operating position, wherein the mounting element (230) and the engagement region (232) are embodied so that and, when the mounting element (230) is located in the adjustment position, they interact such that the connecting element (216) is positioned in the housing (202) in such a way that, with the exception of the engagement region (232), the ignition-safe annular gap between the connecting element (216) and an inner wall of the pass-through opening (214) is formed, and
(b) the mounting element (230) in the operating position releases the connecting element (216).

7. The current transmission device according to claim 6, characterized in that the mounting element (230) is embodied so it can be locked on the connecting element (216) in the operating position and/or the adjustment position.

8. The current transmission device according to claim 7, characterized in that the mounting element (230) is embodied such that it co-forms a labyrinth seal (238) in the operating position.

9. The current transmission device according to claim 8, characterized in that the mounting element (230) is encompassed by a ring element (240), which can be moved from a mounting position into a working position, wherein, in the working position, the ring element (240) is positioned offset with respect to the mounting element (230) in the direction of the housing (202) and forms the labyrinth seal (238) with the mounting element (230) and the housing (202).

10. The current transmission device according to claim 9, characterized in that the housing (202) has a projecting flange (234) surrounding the pass-through opening (214) for co-forming the labyrinth seal, which flange is preferably encompassed by the ring element (240), wherein an annular gap is formed between an inner wall of the ring element (240) and an outer wall of the flange (234).

11. The current transmission device according to claim 1, characterized in that the moveable contact device (222) and the housing-affixed contact device (210) are each embodied as a printed circuit board.

12. The current transmission device according to claim 11, characterized in that the at least one flexible electric contact bridge (226) is embodied as a flexible electrical conductor, in particular as a metallic conductor, for example a gold band or wire.

13. The current transmission device according to claim 11, characterized in that the printed circuit boards forming the moveable contact device (222) and the housing-affixed contact device (210) are mechanically connected to each other in a mounted state.

14. The current transmission device according to claim 13, characterized in that the printed circuit boards are connected via separating points (228), wherein the printed circuit boards are preferably produced together as one piece and the separating points (228) are part of the printed circuit boards.

15. A force measuring apparatus, in particular a weighing apparatus, having a current transmission device (200) according to claim 1.
